(19) United States
(12) Patent Application Publication
(10) Pub. No.: US 2016/0063178 A1
(43) Pub. Date: Mar. 3, 2016

(54) Analysis of Biomolecular Solvation Sites by the 3D-RISM Theory

(71) Applicant: Molecular Design Frontier Co. Ltd., Otsu-shi, Shiga (JP)

(72) Inventors: Fumio HIRATA, Otsu-shi, Shiga (JP); Daniel Jon SINDHIKARA, Kusatsu-shi, Shiga (JP)

(21) Appl. No.: 14/781,539

(22) PCT Filed: Dec. 11, 2013
(86) PCT No.: PCT/JP2013/083808

§ 371 Date: Sep. 30, 2015

(30) Foreign Application Priority Data
Apr. 5, 2013 (JP) PCT/JP2013/060996

(51) Int. Cl. G06F 19/16

(52) U.S. Cl. CPC G06F 19/16

(57) ABSTRACT

This invention is a method for equilibrium solvation-site analysis for biomolecules. The method utilizes 3D-RISM calculations to quickly obtain equilibrium solvent distributions without either necessity of simulation or limits of solvent sampling. The analysis of these distributions extracts highest likelihood poses of solvent as well as localized entropies, enthalpies and solvation free energies. As a test system we used a structure of HIV-1 protease bound to KNI-272 where excellent structural and thermodynamic data is available for comparison. The results, obtained within minutes, show systematic agreement with available experimental data. Further, our results are in good agreement with established simulation-based solvent analysis methods. This method can be used not only for visual analysis of active site solvation but also for virtual screening methods and experimental refinement.

This application is the national phase under 35 U.S.C. §371 of PCT International Application No. PCT/JP2013/083808 which has an International filing date of Dec. 11, 2013 and designated the United States of America.

### BACKGROUND

1. Technical Field

This invention relates to an algorithm and software for investigating solvation sites in biomolecules. It is relevant to the fields of experimental refinement and pharmaceutical design.

2. Description of Related Art

Solvent plays several critical roles in the function of biomolecules. In particular, microscopic effects of solvent such as hydrogen bonding and binding affinity augmentation by the “solvent-displacement effect” are necessary for critical analysis of ligand binding. Minute knowledge of such effects is necessary for reliable prediction, explanation and design of molecular systems. Thus it is no wonder increasing attention is paid by the pharmaceutical-design community to solvent molecules inside active site of protein.

Experimental methodologies for analyzing atomistic water behavior can be extremely useful but are often hindered by limited spatial resolution. Theoretically, sophisticated analysis of water based on simulation has been development for over a decade. In 1998, Lazaridis derived inhomogeneous fluid theory in two landmark papers (NPLs 1-2). Several years later, Young et al developed a solvation site based approach, commonly called “Watermap,” (PTLs1-3) to the forefront by applying Lazaridis' theory towards identification of displaceable water sites to enhance ligand binding (NPLs 3-4). Similarly, recent work by Nguyen et al uses, rather, a grid-based application of Lazaridis' theory (NPL 5).

Although the “explicit-solvent” simulations, on which this analysis is based, enable incredible precision, the sampling problem limits reliable analysis to smaller systems depending on the available computational budget. Even for extremely expensive simulations though, it is questionable whether sufficient sampling of water and ions has occurred in buried regions of the solute where the solvent exchange rate is very slow (NPLs 6-9).

### Patent Literature

PTL 1: U.S. Pat. No. 7,970,581
PTL 2: U.S. Pat. No. 7,970,580
PTL 3: U.S. Pat. No. 7,756,674

### Non Patent Literature

NPL 1: Lazaridis, T. Inhomogeneous Fluid Approach to Solvation Thermodynamics. 2. Applications to Simple Fluids. J Phys Chem B 102, 3542-3550 (1998)
NPL 2: Lazaridis, T. Inhomogeneous fluid approach to solvation thermodynamics. 1. Theory. J Phys Chem B 102, 3531-3541 (1998)
NPL 3: Young, T. T., Abel, R. R., Kim, B. B., Berne, B. J. B. & Friesner, R. A. R. Motifs for molecular recognition exploiting hydrophobic enclosure in protein-ligand binding. Proc. Natl. Acad. Sci. U.S.A. 104, 808-813 (2007)
NPL 4: Abel, R., Young, T., Farid, R., Berne, B. J. & Friesner, R. A. Role of the Active-Site Solvent in the Thermodynamics of Factor Xa Ligand Binding. J. Am. Chem. Soc. 130, 2817-2831 (2008)
NPL 5: Nguyen, C. N., Kurtzman Young, T. & Gilson, M. K. Grid inhomogeneous solvation theory: Hydration structure and thermodynamics of the miniature receptor cucurbit[7]uril. J Chem Phys 137, 044101 (2012)
NPL 6: Deng, Y. & Roux, B. Computation of binding free energy with molecular dynamics and grand canonical Monte Carlo simulations. J Chem Phys 128, 115103-115103-8 (2008)
NPL 7: Michel, J. & Essex, J. W. Prediction of protein-ligand binding affinity by free energy simulations: assumptions, pitfalls and expectations. J Comput Aided Mol Des 24, 639-658 (2010)
NPL 8: Luccarelli, J., Michel, J., Tirado-Rives, J. & Jorgensen, W. L. Effects of Water Placement on Predictions of Binding Affinities for p38a MAP Kinase Inhibitors. Journal of Chemical Theory and Computation 6, 3850-3856 (2010)
NPL 9: Mobley, D. L. Let's get honest about sampling. J Comput Aided Mol Des 1-3 (2012). doi:10.1007/s10822-011-9497-y
NPL 10: Beglov, D. & Roux, B. An integral equation to describe the solvation of polar molecules in liquid water. J Phys Chem B 101, 7821-7826 (1997)
NPL 11: Kovalenko, A. & Hirata, F. Three-dimensional density profiles of water in contact with a solute of arbitrary shape: a RISM approach. Chemical Physics Letters 290, 237-244 (1998)
NPL 12: Imai, T., Hiraoka, R., Kovalenko, A. & Hirata, F. Water Molecules in a Protein Cavity Detected by a Statistical-Mechanical Theory. J Am. Chem. Soc. 127, 15334-15335 (2005)
NPL 13: Imai, T., Hiraoka, R., Kovalenko, A. & Hirata, F. Locating missing water molecules in protein cavities by the three-dimensional reference interaction site model theory of molecular solvation. Proteins 66, 804-813 (2006)
NPL 14: Yokogawa, D., Sato, H. & Sakaki, S. The position of water molecules in Bacteriorhodopsin: A three-dimensional distribution function study. Journal of Molecular liquids, 147, 112-116 (2009)
NPL 15: Sindhikara, D. J., Yoshida, N. & Hirata, F. Placevent: an algorithm for prediction of explicit solvent atom distribution-application to HIV-1 protease and F-ATP synthase. J Comput Chem 33, 1536-1543 (2012)
NPL 16: Stumpe, M. C., Blinov, N., Wishart, D., Kovalenko, A. & Pande, V. S. Calculation of local water densities in biological systems: a comparison of molecular dynamics simulations and the 3D-RISM-KH molecular theory of solvation. J Phys Chem B 115, 319-328 (2010)
NPL 17: Phongphanphanee, S., Yoshida, N. & Hirata, F. The potential of mean force of water and ions in aquaporin channels investigated by the 3D-RISM method. Journal of Molecular liquids, 147, 107-111 (2009)
NPL 18: Yoshida, N., Phongphanphanee, S., Maruyama, Y., Imai, T. & Hirata, F. Selective Ion-Binding by Protein Probed with the 3D-RISM Theory. J. Am. Chem. Soc. 128, 12042-12043 (2006)
NPL 19: Sindhikara, D. J., Yoshida, N., Kataoka, M. & Hirata, F. Solvent penetration in photoactive yellow protein R52Q mutant: A theoretical study. Journal of Molecular Liquids 164, 120-122 (2011)
NPL 20: Palmer, D. S., Frolov, A. I., Ratkova, E. L. & Fedorov, M. V. Towards a universal method for calculating hydration free energies: a 3D reference interaction site model with partial molar volume correction. J Phys.: Condens. Matter 22, 492101 (2010)
NPL 21: Imai, T., Oda, K., Kovalenko, A., Hirata, F. & Kidera, A. Ligand mapping on protein surfaces by the 3D-RISM theory: toward computational fragment-based drug design. J Am. Chem. Soc. 131, 12430-12440 (2009)
NPL 22: Imai, T. et al. Functionality mapping on internal surfaces of multidrug transporter AcrB based on molecular theory of solvation implications for drug efflux pathway. J Phys Chem B 115, 8288-8295 (2011)
NPL 23: Nikolic, D., Blinov, N., Wishart, D. S. & Kovalenko, A. 3D-RISM-Dock: a new fragment-based drug design protocol. Journal of Chemical Theory and Computation (2012). doi:10.1021/ct300257v
NPL 24: Kiyota, Y., Yoshida, N. & Hirata, F. A New Approach for Investigating the Molecular Recognition of Protein: Toward Structure-Based Drug Design Based on the 3D-RISM Theory. Journal of Chemical Theory and Computation 7, 3803-3815 (2011)
NPL 25: Mitchell, J. C. Sampling rotation groups by successive orthogonal images. SIAM Journal on Scientific Computing 30, 525-547 (2008)
NPL 26L Yershova, A., Jain, S., LaValle, S. M. & Mitchell, J. C. Generating Uniform Incremental Grids on SO(3) Using the Hopf Fibration. The International Journal of Robotics Research 29, 801-812 (2010)
NPL 27: Hirata, F. Molecular theory of solvation. (2003)
NPL 28: Imai, T., Kovalenko, A. & Hirata, F. Partial Molar Volume of Proteins Studied by the Three-Dimensional Reference Interaction Site Model Theory. J Phys Chem B 109, 6658-6665 (2005)
NPL 29: Lazaridis, T. & Karplus, M. Orientational correlations and entropy in liquid water. J Chem Phys 105, 4294-4316 (1996)
NPL 30: Adachi, M. et al. Structure of HIV-1 protease in complex with potent inhibitor KNI-272 determined by high-resolution X-ray and neutron crystallography. Proc. Natl. Acad. Sci. U.S.A. 106, 4641-4646 (2009)
NPL 31: Hornak, V. et al. Comparison of multiple Amber force fields and development of improved protein backbone parameters. Proteins: Structure, Function, and Bioinformatics, 65, 712-725 (2006)
NPL 32: Gaussian 09, Revision A. 02, Gaussian. Inc., Wallingford, CT 2, 4 (2009)
NPL 33: Wang, J., Wolf, R. M., Caldwell, J. W., Kollman, P. A. & Case, D. A. Development and testing of a general amber force field. J Comput Chem 25, 1157-1174 (2004)
NPL 34: Word, J. M., Lovell, S. C., Richardson, J. S. & Richardson, D. C. Asparagine and glutamine: using hydrogen atom contacts in the choice of side-chain amide orientation. J Mol. Biol. 285, 1735-1747 (1999)
NPL 35: Dupradeau, F.-Y. et al. The R.E.D. tools: advances in RESP and ESP charge derivation and force field library building. Phys. Chem. Chem. Phys. 12, 7821 (2010)
NPL 36: Luchko, T. et al. Three-dimensional molecular theory of solvation coupled with molecular dynamics in Amber. Journal of Chemical Theory and Computation 6, 607-624 (2010)
NPL 37: Case, D. A. et al. AMBER 12. University of California (2012). at <http://ambermd.org>
NPL 38: Li, Z. & Lazaridis, T. Thermodynamic Contributions of the Ordered Water Molecule in HIV-1 Protease. J. Am. Chem. Soc. 125, 6636-6637 (2003)
NPL 39: Baldwin, E. T. et al. Structure of HIV-1 protease with KNI-272, a tight-binding transition-state analog containing allophenylnorstatine. Structure 3, 581-590 (1995)

### SUMMARY OF THE INVENTION

The invention relates to an algorithm and related software to analyze the local thermodynamics and structural properties of solvation sites in biomolecules using the 3D-RISM theory. The invention produces reliable spatial and thermodynamic properties of solvation sites readily usable for pharmaceutical design.

In order to perform rational drug design, much information is needed about the interactions that affect drug binding. One important factor is the role of solvent sites in the active site. These sites are impossible to characterize experimentally. Conventional techniques such as implicit solvation are fundamentally useless with this regard. Postprocessing of explicit solvent simulations may be useful if it weren't for the fact that these simulations are severely hindered by the computational time to sample solvent (PTLs1-3). Consequently such techniques are either extremely time consuming or simply unreliable. Thus there is no reliable, efficient method for performing analysis of solvation sites, severely limiting pharmaceutical design potential.

This invention utilizes a methodology, 3D-RISM, which quickly obtains reliable, converged solvent structural data for biomolecules, then postprocesses the data in order to clearly characterize solvation sites. The resulting information, including site locations, orientations, and thermodynamic properties can be directly used in pharmaceutical design efforts such as virtual screening/pharmacophore modeling.

This invention will allow much faster analysis of biomolecular sites in various solvent conditions. The analysis will be a boon for pharmaceutical design efforts. The invention showed systematic agreement with high-resolution experimental data and with simulation-based water analysis techniques. Our calculations on HIV-1 protease took just under 11 minutes total on an 8-core workstation. This method can directly take into account cosolvent and ionic effects on solvent structure and thermodynamics, which cannot be realized by more conventional methods such as the continuum solvent models and molecular simulation. Thus we assert that our method is both extremely practical and reasonably accurate method for solvation-site analysis.

The above and further objects and features of the invention will more fully be apparent from the following detailed description with accompanying drawings.

### BRIEF DESCRIPTION OF THE SEVERAL VIEWS OF THE DRAWINGS

FIG. 1 shows a flowchart of the main aspects in the context of expected use of this invention.

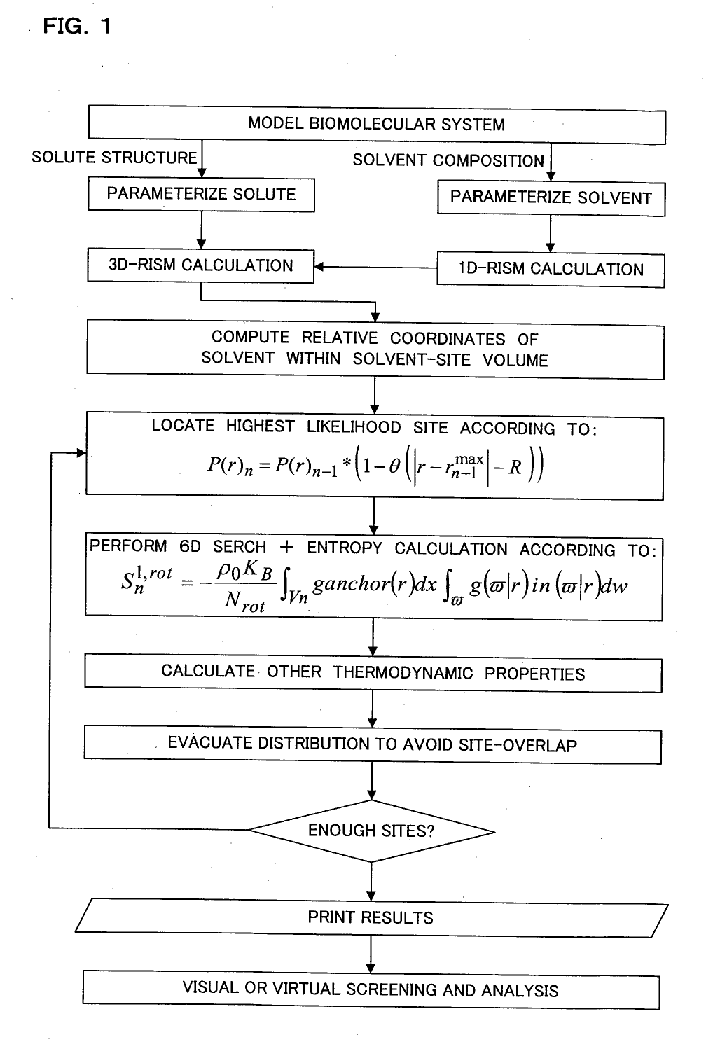

FIG. 2 is a schematic view for showing an appearance of an analyzing apparatus.

FIG. 3 is a block diagram for showing an example configuration of the analyzing apparatus.

FIG. 4 is a flowchart for showing an example procedure performed by a controlling unit.

### DETAILED DESCRIPTION

The invention is illustratively embodied as a computer program written in Python. The program performs file search, reading, analysis and writing.

This invention circumvents the solvent sampling problem by using the three-dimensional reference interaction site model (3D-RISM) theory (NPLs 10-11). 3D-RISM attains complete atomistic sampling of solvent, including ions, by utilizing an integral approach. 3D-RISM has been successful in locating water in proteins compared to experiment (NPLs 12-15) and simulation (NPL 16), ion locations and pathways (NPLs 17-19), hydration free energies (NPL 20), fragment poses (NPLs 21-23), and drug poses (NPL 24), as well as many more applications less relevant to this work. With current implementations, the equilibrium solvent distribution of a biologically relevant system can be calculated in minutes to hours.

3D-RISM first utilizes RISM calculations to find the susceptibility function of the solvent based on specified atomic interaction potentials and mixture concentrations. The solvent susceptibility is then utilized in the 3D-RISM equations, including the atomic solvent-solute interaction potential. The 3D-RISM equations coupled with an appropriate closure relation are iterated until self-consistency resulting in the 3D solvent distribution function g(r), the total correlation function h(r), the direct correlation c(r), as well as other distributions and properties.

To characterize solvation sites, the location of the site must first be identified. We find the sites using the maximum probability in:

P(r)ₙ=P(r)ₙ₋₁*(1−Φ(|r−rₙ₋₁^{max}|−R)) (1)

Here, P(r)₀=ρ₀g(r)₀, n is the iteration number, and R is a preset exclusion radius (here 1 angstrom). This algorithm is iterated until a cutoff is reached, here we cutoff at a number of solvent molecules placed. The resulting discrete distribution represents high occupancy sites whose properties may be of interest in solvation site analysis. The embodiment employs the Successive Orthogonal Images (SOI) approach (NPLs 25-26), which produces more uniform coverage of rotational space. A uniform distribution is obtained by 1) creating a uniform distribution of points on the unit sphere, V¹, 2) for each point on the sphere create a set of uniform vectors, V², also within the unit sphere which are orthogonal to the vector pointing from the center to that point, 3) trivially determine an orthogonal vector to the two previous vectors, 4) determine the rotation, M, expressed in Euler angles corresponding to the three orthogonal vectors based on an arbitrary reference geometry. The resulting set rotations exists within SO(3) and represents a uniform set of rotations. For efficiency in computation we find the optimal angular difference, a, and sizes of |V¹| and |V²| for a fixed number of rotations. Equation 3.1 in NPL 28 shows that |V²|=4π/α² and |V¹|=2π/α thus we set α=(8π²/Nᵣₒₜ)^{1/3} where Nᵣₒₜ=|V²|*|V¹|. We take the solvent atom closest to the center of geometry (Oxygen for water) as a fixed, “anchor” for rotations. For each position of an anchor, the rotational probability distribution function can be described as:

$$P ( ω \vert {r}_{anchor} ) = {Z}^{- 1} {\prod }_{γ ∈ sites} {g}_{γ} ( {r}_{anchor} + {r}_{γ , ω} ) \qquad ( 2 )$$

Here P(ω|r_{anchor}) is the orientational probability distribution function of the solvent given the location of the centermost atomic site, r_{anchor}, r_{γ,ω} is the relative position of the solvent-site γ given rotation co from some arbitrary original geometry Z is the partition function. The solvation-site is defined as the 6D conformational space available by moving the anchor atom within a 1.0 angstrom radius sphere centered on the originally identified location, rₙ. The highest likelihood pose lies at the maximum of P(ω|r) where |r−rₙ|≦R.

The implementation characterizes “solvation sites” using integrations over the solvation site volume, Vₙ. The excess chemical potential or solvation free energy is evaluated simply using the total and direct correlation functions for many 3D-RISM closures including the KH-closure which we use here (NPLs 11-27).

$$Δ {μ}_{n}^{KH} = {ρ}_{0} {k}_{B} T {\sum }_{γ} {\int }_{{V}_{n}} [ \frac{1}{2} {( {h}_{γ} ( r ) )}^{2} Θ ( - {h}_{γ} ( r ) ) - {c}_{γ} ( r ) - \frac{1}{2} {h}_{γ} ( r ) {c}_{γ} ( r ) ] \qquad ( 3 )$$

For the partial molar volume, the adapted Kirkwood-Buff equations toward 3D-RISM data is used (NPL 28):

$${\overline{V}}_{n} = {k}_{B} T {χ}_{T}^{0} ( 1 - {ρ}_{0} {\sum }_{γ} {\int }_{{V}_{n}} {c}_{γ} ( r ) ) \qquad ( 4 )$$

For the energy and entropy, for practical purposes, only the terms first order in the density, that is, the excess solute-solvent terms are used. The general forms are adapted from the GIST expressions (NPL 5) rooted in Lazaridis' work (NPLs 1-2).

$$\begin{matrix}{E}_{n}^{1} = {ρ}_{0} {\sum }_{γ} {\int }_{{V}_{n}} {g}_{γ} ( r ) {u}_{γ} ( r ) & ( 5 ) \\ {S}_{n}^{1 , trans} = - {ρ}_{0} {k}_{B} {\int }_{{V}_{n}} {g}_{anchor} ( r ) ln {g}_{anchor} ( r ) & ( 6 )\end{matrix}$$

For the orientational entropy, an expression for g(ω|r) which is not readily available from 3D-RISM output is required. The expression from Equation 2 for the probability is written in terms of g: g(ω|r)=NᵣₒₜP(ω|r). Using the above equations the expression is given as:

$${S}_{n}^{1 , rot} = - \frac{{ρ}_{0} {k}_{B}}{{N}_{rot}} {\int }_{{V}_{n}} {g}_{anchor} ( r ) {\int }_{ω} g ( ω \vert r ) ln g ( ω \vert r ) \qquad ( 7 )$$

The normalization factor 1/Nᵣₒₜ is different than the usual ⅛π² in accordance with the rotational entropy normalization condition in Equation 5 of reference (NPL 29).

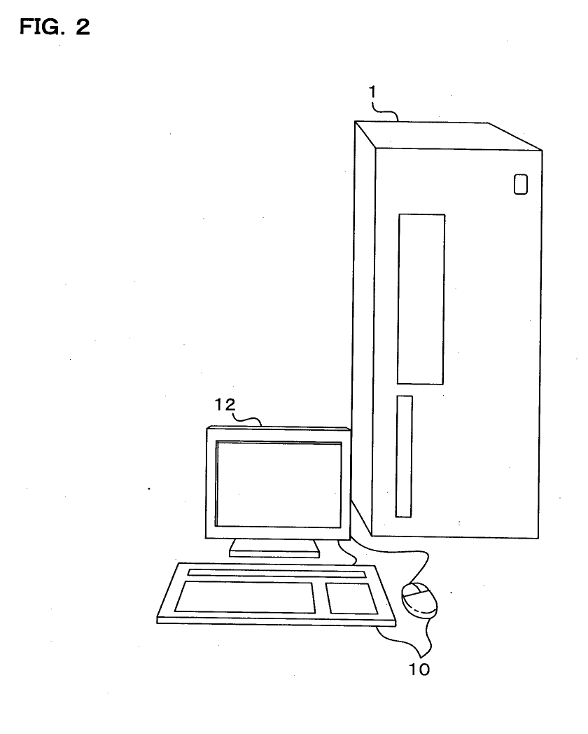

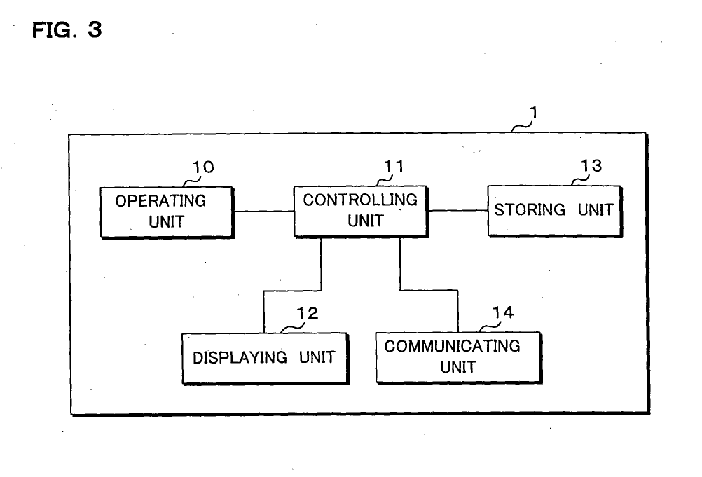

An analyzing apparatus is shown in FIGS. 2 and 3, as an example that can perform the calculations described above.

FIG. 2 is a schematic view for showing an appearance of an analyzing apparatus 1. FIG. 3 is a block diagram for showing an example configuration of the analyzing apparatus 1. The analyzing apparatus 1 includes an operating unit 10, a controlling unit 11, a displaying unit 12, a storing unit 13, and a communicating unit 14.

The operating unit 10 includes hard keys, such as a start key, function keys, and ten keys, and a mouse, and is configured to receive an operation for the analyzing apparatus 1 from a user.

The controlling unit 11 consists of a microcomputer that includes a central processing unit (CPU), a storing medium such as a read only memory (ROM), a memory such as a random access memory (RAM) and the like. In response to the operation received by the operating unit 10, the controlling unit 11 sends a control signal to each unit of the analyzing apparatus 1 so as to control each unit.

The display 12 consists of a liquid crystal panel, and displays an image based on the control signal sent from the controlling unit 11. Alternatively, the display 12 may consist of a plasma display panel, an organic EL panel, or the like. The storing unit 13 consists of a RAM, and stores formulas utilized for the calculations according to the present invention, computer programs utilized for controlling the analyzing apparatus 1 to perform the calculations according to the present invention, and the like. The storing unit 13 stores information about the interaction between the solvent and the solute, and the like. It may be configured that the storing unit 13 reads these computer programs and the like from a recording medium that records these computer programs and the like, so as to store the read programs and the like. Alternatively, it may be configured that the storing unit 13 obtains these computer programs and the like from an external apparatus through the communicating unit 14 described later. In addition, the storing unit 13 may consist of a storing medium other than the RAM, such as a HDD.

The communicating unit 14 consists of an Ethernet connection port, and is configured to communicate with the external apparatus through a communication network, such as an Internet. It is configured that the data obtained by the communication of the communicating unit 14 can be stored in the storing unit 13.

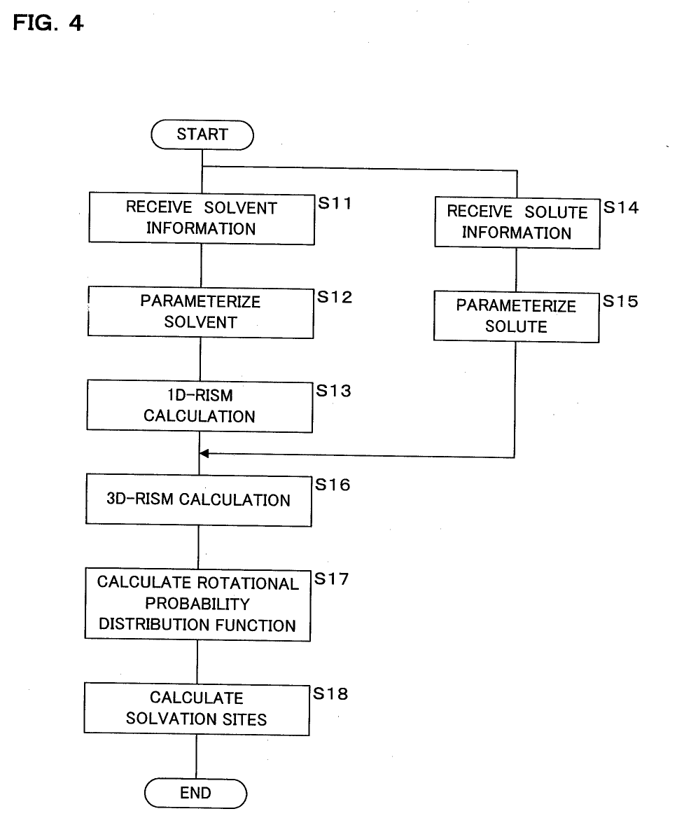

FIG. 4 is a flowchart for showing an example procedure performed by the controlling unit 11. In the procedure, a biomolecular solvation sites are analyzed in accordance with the solvent information and the solute information.

The controlling unit 11 receives the solvent information including composition information via the operating unit 10 (step S11), and parameterizes the solvent information (step S12). The controlling unit 11 performs the 1D-RISM calculation with the parameterized solvent information to find the susceptibility function of the solvent (step S13).

The controlling unit 11 additionally receives the solute information including structure information via the operating unit 10 (step S14), and parameterizes the solute information (step S15). The controlling unit 11 performs the 3D-RISM calculation with the parameterized solute information and with the result of the performed 1D-RISM calculation (step S16), to find the atomic solvent-solute interaction potential.

Based on the results of the 3D-RISM calculation, the controlling unit 11 calculates the rotational probability distribution function with the formula (2) described above (step S17). Based on the results of the 3D-RISM calculation and the calculated rotational probability distribution function, the controlling unit 11 calculates the solvation sites, highest likelihood sites, with the formula (1) described above (step S18).

The controlling unit 11 utilizes the calculated solvation sites to create a visual image for analyzing the solvation and ends the procedure.

### (Calculation Details)

System geometries tested for this implementation were taken from the PDB: HIV-1 protease (2ZYE) (NPL 30). Protein interaction parameters were taken from the ff99SB parameter set (NPL 31). KNI-272 was parameterized using Gaussian 09 (NPL 32) using HF 6-31 G* basis set and GAFF parameters (NPL 33) using antechamber (NPL 34) with RED IV (NPL 35) parameterization. Protonation states were taken from available deuterium data from the experimental structure. Alanine Dipeptide structure and all parameters were prepared using tLEaP. Pure water at 55.5 M using modified SPC parameters (NPL 36). 3D-RISM calculations were run using the Amber Tools rism3d.snglpnt.MPI module (NPLs 36-37). All calculations were performed on an HP Z100 8-core Intel 3.2 GHz Xeon workstation. The 3D-RISM calculation on HIV-1 protease and Alanine Dipeptide using the KH closure took 6.5 minutes and 39 seconds respectively. Postprocessing was performed using a Python script, which took 4.3 minutes to run in serial.

### (Results)

The embodiment was tested by comparing experimental waters to their nearest predicted solvation site and compared the RMSD between the pair of poses with −TS. Linear fits give r=−0.47 and r=−0.67 for −TSₜᵣₐₙₛ and −TSᵣₒₜ respectively. The strongest correlation was with the total contribution of entropy to the free energy, −TSᵣₒₜ where r=−0.76. −TSₜᵣₐₙₛ had a r=−0.48 against distance between experimental and predicted oxygens. The experimental B-factor also had a correlation of r=0.46 with the O-O distance. The data suggest that there is a reasonable correlation between “structural predictability” and entropy.

Next, quantitative comparisons of thermodynamic quantities to those obtained by simulation-based analysis were obtained. In 2003, Li and Lazaridis (NPL 38) studied an isolated water bound between the flaps and the inhibitor KNI-272 bound from of HIV-1 protease using structure 1HPX (NPL 39) and the simulation-based approach. In Table 1, their data is compared to the results of this implementation. For this water, the estimates for solvation free energy agreed to less than 1 kcal/mol. The entropic contribution was underpredicted by 1-2 kcal/mol. The solvent-solute interaction energy was also under-predicted by about 7 kcal/mol. While the differences may be partly attributed to force field differences and solute structures, other factors are likely due to limitation of methodological errors for generating the initial data (sampling error in simulation and closure error in 3DRISM).

| Study/property | Li et al 8 ns | Li et al 1 ns | Here |
|---|---|---|---|
| ΔG (kcal/mol) | −15.2 | −15.9 | −15.96 |
| −TΔS (kcal/mol) | 2.940 | 3.30 | 1.14 |
| ΔE¹ (kcal/mol) | −28.2 | −28.0 | −35.2 |

Although Lazaridis' work calculates the total solvation free energy by addition of explicit terms, this implementation calculates only the first order terms in energy and entropy but calculates the solvation free energy directly. The PV term in the free energy for most the sites including the flap water, this term was nearly zero.

The site in the vicinity of KNI-272, the “flap” water, despite its steep entropic penalty, favorably contributes to the solvation free energy. The results included less favorable waters nearby the inhibitor (e.g. water 354 with 4G=−4.96 kcal/mol) as well as other sites in the hinge region as high as −0.93, and near the termini as high as +1.65 kcal/mol. Such water sites may be reasonable targets for displacement in drug-design efforts.

### INDUSTRIAL APPLICABILITY

This invention can be used by pharmaceutical scientists and molecular design scientists in order to better understand the microscopic solvent effects in their system, enabling intelligent design.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-9. (canceled)

10. A method to for postprocessing solvent distributions from 3D-RISM, comprising:
locating solvation sites;
performing a six-dimensional search for solvent poses;
determining an optimal solvent pose using a 3D-RISM-based weight function;
calculating a site first order excess translational entropy using 3D-RISM distribution;
calculating a site first order excess rotational entropy using an orientational distribution function based on an orientational search;
calculating a site partial molar volume using 3D-RISM total and direct correlation functions;
calculating a site solvation free energy using 3D-RISM total and direct correlation functions; and
calculating a site average solute-solvent interaction potential using a solvent interaction potential and a 3D-RISM distribution function.

11. A method for postprocessing solvent distributions after a 3D-RISM process, comprising:
locating solvation sites using a process of evacuation according to equation (1);
performing a six-dimensional search for solvent poses scoring each pose by equation (2), within a volume of the located solvation sites, resulting in a 6-D probability distribution function for that site;
determining an optimal solvent pose based on the performed six-dimensional search;
calculating a site first order excess translational entropy within the volume of the located solvation sites;
calculating a site first order excess rotational entropy using an orientational distribution function based on the performed six-dimensional search;
calculating a site partial molar volume by performing a volume integral in the located solvation sites;
calculating a site solvation free energy by performing a volume integral in the located solvation sites; and
calculating a site average solute-solvent interaction potential by performing a volume integral in the located solvation sites.
$$\begin{matrix}{P ( r )}_{n} = {P ( r )}_{n - 1} * ( 1 - Θ ( \vert r - {r}_{n - 1}^{ma x} \vert - R ) ) & ( 1 ) \\ P ( ω \vert {r}_{anchor} ) = {Z}^{- 1} {\prod }_{γ ∈ sites} {g}_{γ} ( {r}_{anchor} + {r}_{γ , ω} ) & ( 2 )\end{matrix}$$
P(r)ₙ: population of solvent molecules in a sphere of the exclusion radius at position r
P(ω|r_{anchor}): orientational probability distribution function of a solvent molecule
r: coordinate
n: iteration number
R: exclusion radius
Φ: Heaviside function
γ: solvent site from an arbitrary original geometry
ω: given rotation from the arbitrary original geometry
Z: partition function
g: correlation function

12. A method for analyzing biomolecular solvation sites in biomolecules including a solvent and a solute, comprising:
performing a RISM calculation to find a susceptibility of the solvent;
performing a 3D-RISM calculation based on the found susceptibility to obtain a 3D distribution of the solvent; and
identifying solvation sites of the solvent and the solute with an equation (1), based on the obtained 3D distribution.
P(r)ₙ=P(r)ₙ₋₁*(1−Φ(|r−rₙ₋₁^{max}|−R)) (1)
P(r)ₙ: population of solvent molecules in a sphere of the exclusion radius at position r
r: coordinate
n: iteration number
R: exclusion radius
Φ: Heaviside function

13. The method according to claim 12, further comprising
calculating a rotational probability of the solvent with an equation (2), wherein
the solvation sites are identified in accordance with the calculated rotational probability.
$$P ( ω \vert {r}_{anchor} ) = {Z}^{- 1} {\prod }_{γ ∈ sites} {g}_{γ} ( {r}_{anchor} + {r}_{γ , ω} ) \qquad ( 2 )$$
P(ω|r_{anchor}): orientational probability distribution function of a solvent molecule
γ: solvent site from an arbitrary original geometry
ω: given rotation from the arbitrary original geometry
Z: partition function
g: correlation function

14. An analyzing apparatus that analyzes biomolecular solvation sites in biomolecules including a solvent and a solute, comprising:
a RISM calculation unit that performs a RISM calculation to find a susceptibility of the solvent;
a 3D-RISM calculation unit that performs a 3D-RISM calculation based on the found susceptibility to obtain a 3D distribution of the solvent; and
an identification unit that identifies solvation sites of the solvent and the solute with an equation (1), based on the obtained 3D distribution.
P(r)ₙ=P(r)ₙ₋₁*(1−Φ(|r−rₙ₋₁^{max}|−R)) (1)
P(r)ₙ: population of solvent molecules in a sphere of the exclusion radius at position r
r: coordinate
n: iteration number
R: exclusion radius
Φ: Heaviside function

15. The analyzing apparatus according to claim 14, further comprising
a rotational-probability calculation unit that calculates a rotational probability of the solvent with an equation (2), wherein
the identification unit identifies the solvation sites in accordance with the calculated rotational probability.
$$P ( ω \vert {r}_{anchor} ) = {Z}^{- 1} {\prod }_{γ ∈ sites} {g}_{γ} ( {r}_{anchor} + {r}_{γ , ω} ) \qquad ( 2 )$$
P(ω|r_{anchor}): orientational probability distribution function of a solvent molecule
γ: solvent site from an arbitrary original geometry
ω: given rotation from the arbitrary original geometry
Z: partition function
g: correlation function

16. A non-transitory recording medium in which a computer program is recorded, the computer program controlling a computer to analyze biomolecular solvation sites in biomolecules including a solvent and a solute, wherein
the computer program when executed controls the computer to execute the steps of:
performing a RISM calculation to find a susceptibility of the solvent;
performing a 3D-RISM calculation based on the found susceptibility to obtain a 3D distribution of the solvent; and
identifying solvation sites of the solvent and the solute with an equation (1), based on the obtained 3D distribution.
P(r)ₙ=P(r)ₙ₋₁*(1−Φ(|r−rₙ₋₁^{max}|−R)) (1)
P(r)ₙ: population of solvent molecules in a sphere of the exclusion radius at position r
r: coordinate
n: iteration number
R: exclusion radius
Φ: Heaviside function

17. The non-transitory recording medium according to claim 16, wherein
the computer program when executed controls the computer to further execute the step of
calculating a rotational probability of the solvent with an equation (2), wherein
the solvation sites are identified in accordance with the calculated rotational probability.
$$P ( ω \vert {r}_{anchor} ) = {Z}^{- 1} {\prod }_{γ ∈ sites} {g}_{γ} ( {r}_{anchor} + {r}_{γ , ω} ) \qquad ( 2 )$$
P(ω|r_{anchor}): orientational probability distribution function of a solvent molecule
γ: solvent site from an arbitrary original geometry
ω: given rotation from the arbitrary original geometry
Z: partition function
g: correlation function
